(19) United States
(12) Patent Application Publication
(10) Pub. No.: US 2007/0013876 A1
(43) Pub. Date: Jan. 18, 2007

(54) Projecting device

(76) Inventors: Ken Agatsuma, Tokyo (JP); Shohei Matsuoka, Tokyo (JP)

Correspondence Address: PITNEY HARDIN LLP, 7 TIMES SQUARE, NEW YORK, NY, 10036-7311, US

(21) Appl. No.: 11/484,958

(22) Filed: Jul. 12, 2006

(30) Foreign Application Priority Data
Jul. 12, 2005 (JP) 2005-202797

(51) Int. Cl. G03B 21/14

(52) U.S. Cl. 353/70

(57) ABSTRACT

A projecting device includes a first projective optical system forming an intermediate image having trapezoidal distortion from light emitted by a display unit displaying a rectangular image, a second projective optical system projecting the light from the intermediate image obliquely onto a screen so that an enlarged image in which the trapezoidal distortion has been corrected will be projected on the screen, and an intermediate optical system leading the light to combine the two projective optical systems. The second projective optical system includes at least one lens having a surface on which first and second ray bundles emitted from both ends of the image displayed by the display unit in regard to a short side direction of the image are totally separate from each other. A prescribed lens included in the at least one lens is configured so that gradients and curvatures at particular positions will satisfy prescribed conditions.

### BACKGROUND OF THE INVENTION

The present invention relates to a projecting device which first forms an intermediate image in a trapezoidal shape (image having trapezoidal distortion) from light emitted by a display unit displaying a rectangular image and thereafter projects the light after forming the intermediate image onto a screen obliquely so that an enlarged image in which the trapezoidal distortion has been corrected will be projected on the screen.

Projecting devices of the oblique projection type, capable of projecting an image displayed by a display unit onto a screen obliquely without causing trapezoidal distortion, are well known today. Such a projecting device of the oblique projection type (hereinafter simply referred to as a “projecting device”) generally includes a display unit which displays an image, a display unit-side projective optical system which forms an intermediate image from light emitted by the display unit, a screen-side projective optical system which leads light from the intermediate image to a screen, and a deflecting optical system which deflects light from the display unit-side projective optical system toward the screen-side projective optical system. In such a projecting device, each optical element is tilted in regard to an optical axis so that the Scheimpflug rule will be satisfied among the display unit, the display unit-side projective optical system and the intermediate image and also among the intermediate image, the screen-side projective optical system and the screen. An example of such a projecting device is disclosed in Japanese Patent Provisional Publication No. HEI 06-265814, for example.

In a projecting device described in the above patent document, the intermediate image formed by the display unit-side projective optical system has the trapezoidal distortion, whereas the image obliquely projected onto the screen is a substantially rectangular image in which the trapezoidal distortion has been corrected satisfactorily. Incidentally, such a projecting device is generally designed so that the size of the projected image (on the screen) in the horizontal direction of the device in ordinary use will be larger than the size of the image in the vertical direction of the device.

However, in the above configuration, a change in aspect ratio that occurs between the image on the display unit and the projected image on the screen is innately dependent on magnifications of the display unit-side projective optical system and the screen-side projective optical system. Especially, magnification in the vertical direction tends to get larger than necessary since each projective optical system is configured to let the light enter the screen obliquely (e.g. upward). For this reason, the degree of freedom in selecting the magnification of each projective optical system is restricted if the projecting device is designed focusing on maintenance of a proper aspect ratio. On the other hand, increasing the degree of freedom in the selection of magnification of each projective optical system makes it difficult to maintain the aspect ratio.

Further, as general properties of the display unit-side projective optical system, the maintenance of aspect ratio becomes easier as the magnification decreases, while correction of the aspect ratio becomes almost impossible if the display unit-side projective optical system is designed to have paraxial magnification larger than 1. However, decreasing the magnification (attaching importance to the maintenance of aspect ratio) can cause another problem of heat concentration in the vicinity of the intermediate image formed by the display unit-side projective optical system.

Furthermore, while it is well known that reduction of the thickness of the projecting device (in a direction orthogonal to the screen) can be achieved more easily as the incident angle of the light entering the screen increases, simply increasing the incident angle leads to an improper aspect ratio. With no effective configuration regarding the balance between the incident angle and the aspect ratio described in the above patent document, further improvements have been hoped for.

### SUMMARY OF THE INVENTION

The present invention is advantageous in that a projecting device of the oblique projection type, facilitating the maintenance of aspect ratio while securing a high degree of freedom in the selection of magnification of each projective optical system, can be provided while also realizing a reduced thickness of the projecting device (in the direction orthogonal to the screen) by increasing the incident angle of the light entering the screen.

In accordance with an aspect of the present invention, there is provided a projecting device comprising: a display unit which displays an image in a rectangular shape; a first projective optical system which forms an intermediate image having trapezoidal distortion from light emitted by the display unit; a second projective optical system which receives the light after forming the intermediate image and projects the light obliquely onto a screen so that an enlarged image in which the trapezoidal distortion has been corrected will be projected on the screen; and an intermediate optical system which combines pupils of the first and second projective optical systems and leads the light emerging from the first projective optical system to the second projective optical system.

In the projecting device, at least the second projective optical system includes at least one lens having a surface on which a first ray bundle emitted from one end of the image displayed by the display unit in regard to a short side direction of the image and a second ray bundle emitted from the other end of the image in regard to the short side direction are totally separate from each other.

A prescribed lens included in the at least one lens has a first surface on the screen side and a second surface on the display unit side and satisfies the following condition (1) in regard to a third ray bundle emitted from the center of the image displayed by the display unit:
s1−s2>0 (1)

where s1 denotes a gradient of a tangent line to the first surface in a lengthwise direction (corresponding to a vertical direction of the screen) measured at a position where a principal ray of the third ray bundle crosses the first surface and s2 denotes a gradient of a tangent line to the second surface in the lengthwise direction measured at a position where the principal ray of the third ray bundle crosses the second surface.

Further, the prescribed lens satisfies the following condition (2):
(c1−c3)>(c2−c4) (2)

where c1 and c2 denote curvatures of the first surface in the lengthwise direction and in a crosswise direction (corresponding to a horizontal direction of the screen) measured at the position where the principal ray of the third ray bundle crosses the first surface and c3 and c4 denote curvatures of the second surface in the lengthwise direction and in the crosswise direction measured at the position where the principal ray of the third ray bundle crosses the second surface.

In the projecting device configured as above, by designing the prescribed lens to satisfy the condition (1), the incident angle of the light entering the screen can be increased, that is, the thickness of the projecting device in a direction orthogonal to the screen can be decreased. Further, by designing the prescribed lens to satisfy the condition (2), an effect of stretching the image in the horizontal direction can be achieved and that makes it possible to maintain the aspect ratio properly even when the incident angle of the light entering the screen is increased.

Preferably, the prescribed lens satisfies the following condition (3):
Cd<Cc<Cu (3)

where Cu denotes difference between curvature of the first surface in the lengthwise direction measured at a position where a principal ray of the first ray bundle crosses the first surface and curvature of the second surface in the lengthwise direction measured at a position where the principal ray of the first ray bundle crosses the second surface, Cd denotes difference between curvature of the first surface in the lengthwise direction measured at a position where a principal ray of the second ray bundle crosses the first surface and curvature of the second surface in the lengthwise direction measured at a position where the principal ray of the second ray bundle crosses the second surface, and Cc denotes difference between the curvature of the first surface in the lengthwise direction measured at the position where the principal ray of the third ray bundle crosses the first surface and the curvature of the second surface in the lengthwise direction measured at the position where the principal ray of the third ray bundle crosses the second surface.

More preferably, the prescribed lens satisfies the following condition (4) in relation to a tilt angle α (degrees) of the display unit relative to a plane orthogonal to an optical axis of the first projective optical system:

$$1 \leq \frac{Cu - Cc}{Cc - Cd} < {( \frac{- 2 sin α + cos α}{- sin α + cos α} )}^{2} . \qquad ( 4 )$$

Preferably, each of the first and second surfaces of the prescribed lens has a shape defined by the following expression (5):

$$X ( y , z ) = \frac{{y}^{2} + {z}^{2}}{r ( 1 + \sqrt{1 - \frac{( K + 1 ) ( {y}^{2} + {z}^{2} )}{{r}^{2}}} )} + \sum {B}_{mn} {y}^{m} {z}^{n} \qquad ( 5 )$$

where X(y, z) denotes a SAG amount from a tangential plane contacting the surface on its optical axis to a point on the surface having coordinates (y, z) when the tangential plane is expressed in a coordinate system specified by a Y-axis extending in the lengthwise direction from the optical axis and a Z-axis orthogonal to both the optical axis and the Y-axis to have an origin as an intersection point of the Y-axis, the Z-axis and the optical axis, r denotes a curvature radius, K denotes a cone constant, and Bₘₙ denotes an aspherical coefficient for each term y^{m}zⁿ. At least one of the first and second surfaces is a polynomial surface that is rotationally asymmetric around the optical axis with a nonzero aspherical coefficient Bₘₙ in which m≠n. The aspherical coefficient B₄₀ of the first surface is set larger than that of the second surface.

With the above configuration, the condition (3) can be satisfied without using aspherical coefficients of higher orders.

Preferably, each of the first and second surfaces of the prescribed lens is a rotationally symmetric aspherical surface having a shape defined by the following expression (6):

$$X ( y ) = \frac{{Cy}^{2}}{1 + \sqrt{1 - ( K + 1 ) {C}^{2} {y}^{2}}} + {A}_{4} {y}^{4} + {A}_{6} {y}^{6} + … \qquad ( 6 )$$

where X (y) denotes a SAG amount from a tangential plane contacting the aspherical surface on its rotational symmetry axis to a coordinate point on the aspherical surface where height from the rotational symmetry axis is y, C denotes curvature of the aspherical surface on the rotational symmetry axis, K denotes a cone constant, and A_{4,} A₆, . . . denote aspherical coefficients. The aspherical coefficients A₄ and A₆ of the fourth and sixth orders are both nonzero for at least one of the first and second surfaces. At least the prescribed lens is shifted from an optical axis of the second projective optical system.

With the above configuration, an effect similar to that of the above projecting device can be achieved.

Preferably, the prescribed lens is configured so that difference between curvature of the first surface due to aspherical components and curvature of the second surface due to aspherical components will be positive and increase as the height from the rotational symmetry axis increases.

Preferably, in the second projective optical system, a lens placed on the screen side of a screen-side pupil (pupil on the screen side) of the second projective optical system is employed as the prescribed lens.

In the above configuration, when the prescribed lens is configured to have positive paraxial power, it is desirable that the prescribed lens be shifted from the optical axis of the second projective optical system to separate from an intersection line where three planes extending from the screen, a principal plane of the second projective optical system and an image plane of the intermediate image intersect with one another. When the prescribed lens is configured to have negative paraxial power, it is desirable that the prescribed lens be shifted from the optical axis of the second projective optical system toward the intersection line.

Preferably, the short side direction corresponds to the vertical direction of the image projected and displayed on the screen. The one end and the other end in regard to the short side direction are an upper end and a lower end of the image displayed by the display unit respectively.

### BRIEF DESCRIPTION OF THE ACCOMPANYING DRAWINGS

FIG. 1 is a schematic diagram showing the overall composition of a projecting device in accordance with an embodiment of the present invention.

FIG. 2 is a schematic diagram mainly showing the composition of a projective optical system of the projecting device, in which optical paths inside the projecting device (between the projective optical system and a screen) are unfolded for convenience.

FIG. 3 is a schematic diagram for explaining the arrangement of the screen and elements of the projective optical system.

FIG. 4 is an enlarged view showing optical paths of first through third ray bundles in the vicinity of a corrective lens which is included in the projective optical system.

FIG. 5 is a schematic diagram mainly showing the composition of a projective optical system of a projecting device as a second example of the embodiment, in which optical paths between the projective optical system and the screen are unfolded for convenience.

FIG. 6 is a schematic diagram mainly showing the composition of a projective optical system of a projecting device as a third example of the embodiment, in which optical paths between the projective optical system and the screen are unfolded for convenience.

FIG. 7 is a graph showing distortion of images actually projected by projecting devices as first and second examples of the embodiment.

FIG. 8 is a graph showing distortion of an image actually projected by the projecting device as the third example of the embodiment.

### DETAILED DESCRIPTION OF THE EMBODIMENTS

Referring now to the drawings, a description will be given in detail of a preferred embodiment in accordance with the present invention.

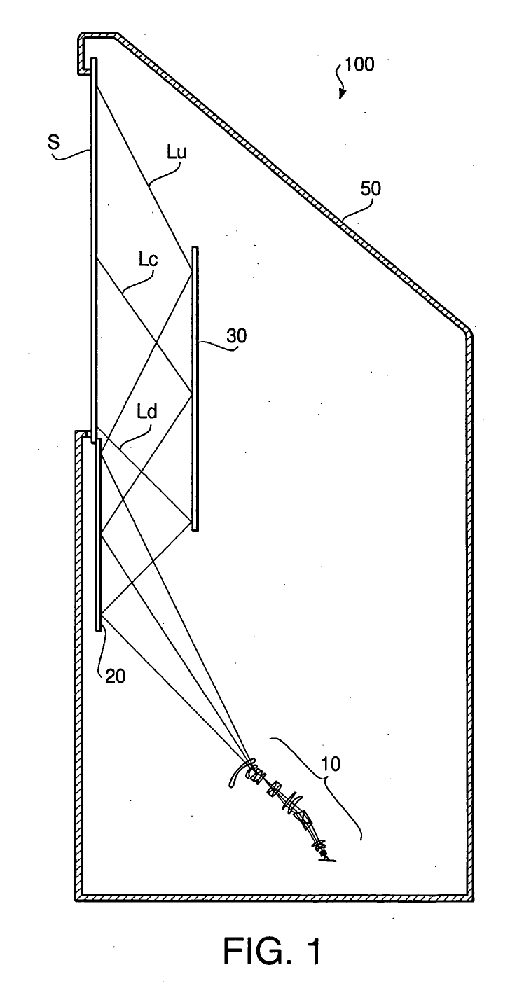

FIG. 1 is a schematic diagram showing the overall composition of a projecting device 100 of the oblique projection type in accordance with an embodiment of the present invention. In FIG. 1, the projecting device 100 in ordinary use (ordinary position) is shown. The projecting device 100 includes a projective optical system 10, a first mirror 20, a second mirror 30 and a screen S which are placed inside a housing 50.

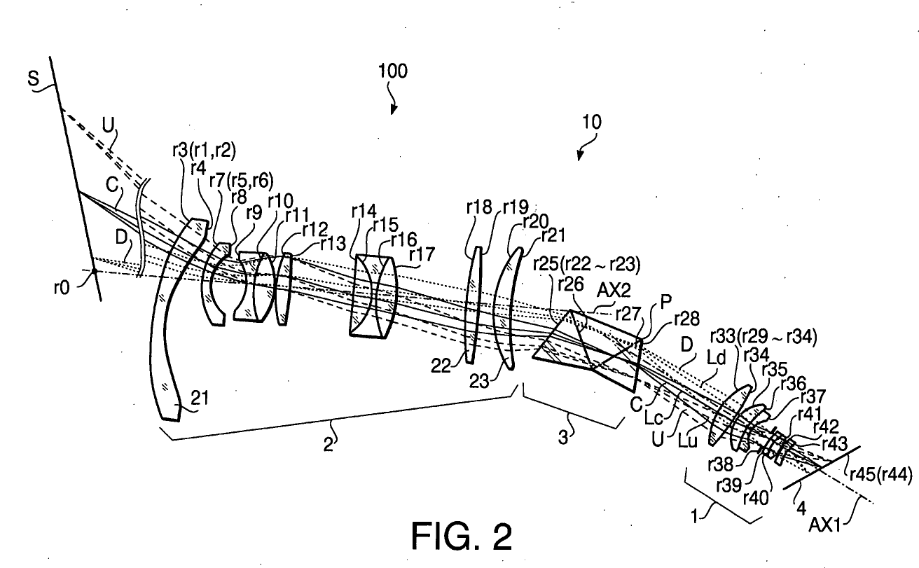

FIG. 2 is a schematic diagram mainly showing the composition of the projective optical system 10, in which the first and second mirrors 20 and 30 are unshown and optical paths inside the projecting device 100 (between the projective optical system 10 and the screen S) are unfolded for convenience. As shown in FIG. 2, the projective optical system 10 includes a first projective optical system 1, a second projective optical system 2, a deflecting optical system 3 and a display unit 4. In FIG. 2, “AX1” represents an optical axis of the first projective optical system 1 and “AX2” represents an optical axis of the second projective optical system 2. In each figure, the optical axes AX1 and AX2 will be indicated with chain lines. Therefore, FIG. 2 is actually a cross-sectional view of the projective optical system 10 taken along a plane (of FIG. 2) containing the optical axes AX1 and AX2 of the first and second projective optical systems 1 and 2. Incidentally, the plane containing the optical axes AX1 and AX2 substantially bisects the screen S along a line passing through the center of the screen S and extending in the vertical direction. In the following description, the plane containing the optical axes AX1 and AX2 will be referred to as a “reference plane” for convenience of explanation.

In the projecting device 100 of this embodiment, lenses (and some optical surfaces) forming each of the first and second projective optical systems 1 and 2 are decentered from one another in order to correct aberrations and distortions that can not be corrected sufficiently by an optical system having rotational symmetry. For this reason, a line containing the largest number of centers of optical surfaces is defined as the optical axis of each optical system. Incidentally, when the centers of optical surfaces are all shifted from one another in a particular projective optical system, a line passing through the center of an optical surface nearest to the pupil is defined as the optical axis of the optical system.

In the following explanation of each element of the projecting device 100, a direction corresponding to the vertical direction of the image projected on the screen S of the projecting device 100 in ordinary use will be called a “lengthwise direction”. Meanwhile, a direction corresponding to the horizontal direction of the image projected on the screen S will be called a “crosswise direction”. The “vertical direction” is a direction substantially vertical in FIG. 1 and the “horizontal direction” is a direction orthogonal to the sheet of FIG. 1, and thus the “crosswise direction” is also the direction orthogonal to the sheet of FIG. 1. A dimension (size) in the lengthwise direction will be called “height”, while a dimension (size) in the crosswise direction will be called “width”. The image displayed by the display unit 4 of this embodiment is in a rectangular shape with a prescribed aspect ratio in which the height is smaller than the width. Therefore, a “short side direction” of the image displayed by the display unit 4 means the lengthwise direction. It is assumed in this embodiment that the projecting device 100 is configured to project light onto the screen S from below.

Incidentally, while the actual projecting device 100 may be designed to fold the optical paths by use of not only the first and second mirrors 20 and 30 but also one or more extra mirrors (unshown) placed inside the projective optical system 10 depending on the shape of the housing 50 and the positional relationship among the elements, the following explanation of each element will be given neglecting the folding of the optical paths and assuming an imaginary state in which the optical paths are unfolded for convenience.

The display unit 4 displays an image to be enlarged and projected onto the screen S. Light emitted by the display unit 4 passes through the first projective optical system 1 and forms an intermediate image. In this embodiment, the image plane P of the intermediate image substantially coincides with an optical surface of the deflecting optical system 3 nearest to the first projective optical system 1.

The deflecting optical system 3 is an optical system which combines the pupils of the first and second projective optical systems 1 and 2. Specifically, the deflecting optical system 3 is formed of three triangular prisms. By forming the deflecting optical system 3 with triangular prisms (which can be manufactured at low costs and with high efficiency), aberrations that can occur in the deflecting optical system 3 are restricted to the so-called basic aberrations such as axial chromatic aberration and spherical aberration. Therefore, such a configuration of the deflecting optical system 3 facilitates the correction of aberrations compared to conventional configurations involving asymmetric aberrations due to decentering, etc. The deflecting optical system 3 deflects and leads the light after forming the intermediate image to the second projective optical system 2. Although in concrete examples (which are described below) of the projecting device 100 the triangular prisms forming the deflecting optical system 3 have no power, the triangular prisms may have a certain power depending on positions of the pupils.

The second projective optical system 2 diverges the light incident thereon via the deflecting optical system 3. The diverging light emerging from the second projective optical system 2 (i.e. emerging from the projective optical system 10) is successively reflected by the first and second mirrors 20 and 30 and is incident upon the rear surface (surface facing the inside of the projecting device 100) of the screen S obliquely. By the above process, the image displayed by the display unit 4 is enlarged and projected on the screen S.

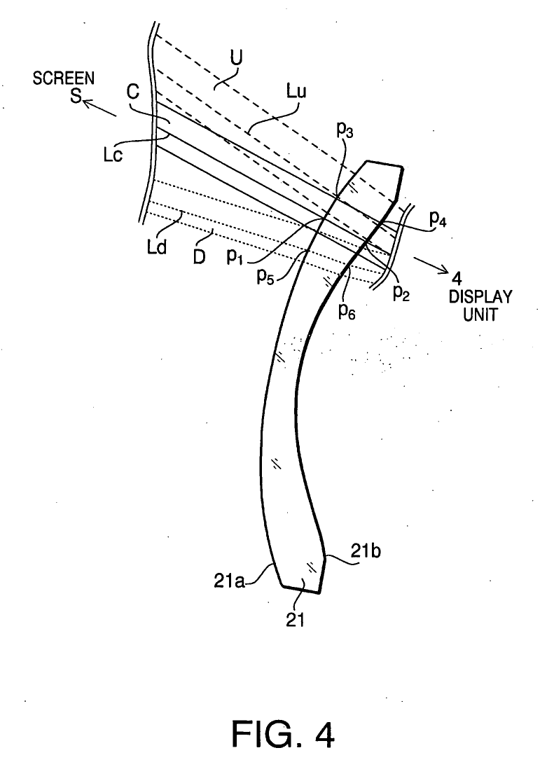

In the following explanation referring to figures, ray bundles of the light (projected on the screen S) on the line passing through the image center of the screen S and extending in the vertical direction will be called according to the following definition. A ray bundle forming the upper end of the image will be called a “first ray bundle U” and the principal ray of the first ray bundle U will be called a “principal ray Lu”. A ray bundle forming the lower end of the image will be called a “second ray bundle D” and the principal ray of the second ray bundle D will be called a “principal ray Ld”. A ray bundle forming the center of the image will be called a “third ray bundle C” and the principal ray of the third ray bundle C will be called a “principal ray Lc”. In FIG. 2 (and in FIGS. 4-6 which will be referred to later), the first ray bundle U and its principal ray Lu are indicated with broken lines, the second ray bundle D and its principal ray Ld are indicated with dotted lines, and the third ray bundle C and its principal ray Lc are indicated with solid lines. In the following explanation, “the upper/lower end of the image” means the upper/lower end of the image on the line passing through the center of the screen S and extending in the vertical direction.

The screen S has a thin-film Fresnel lens (unshown) applied thereon, by which the light obliquely entering the rear surface of the screen S emerges from the front surface (surface on the user's or viewer's side) of the screen S substantially in the direction orthogonal to the screen S.

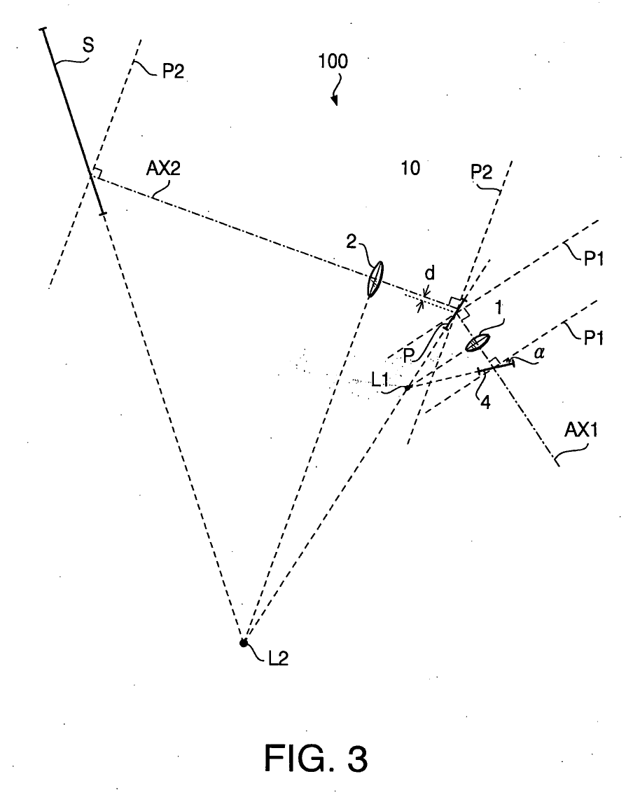

FIG. 3 is a schematic diagram for explaining the arrangement of the screen S and the elements of the projective optical system 10, in which the first and second projective optical systems 1 and 2 are simply represented as single lenses for convenience of explanation. As shown in FIG. 3, the display unit 4, the first projective optical system 1 and the image plane P of the intermediate image are arranged to be oblique to one another so as to satisfy the Scheimpflug rule, that is, three planes extending from the display unit 4, (the principal plane of) the first projective optical system 1 and the image plane P intersect with one another on the same line L1 (hereinafter referred to as a “first reference line L1”). Specifically, the display unit 4 is tilted relative to an imaginary plane P1 (hereinafter referred to as a “first imaginary plane P1”) which is orthogonal to the optical axis AX1 of the first projective optical system 1. The tilt angle of the display unit 4 (relative to the first imaginary plane P1) is indicated as “α” in FIG. 3. Similarly, the image plane P of the intermediate image is also tilted relative to the first imaginary plane P1.

Meanwhile, the screen S, the second projective optical system 2 and the image plane P of the intermediate image are also arranged to be oblique to one another so as to satisfy the Scheimpflug rule, that is, three planes extending from the screen S, (the principal plane of) the second projective optical system 2 and the image plane P intersect with one another on the same line L2 (hereinafter referred to as a “second reference line L2”). Specifically, the image plane P of the intermediate image is tilted not only relative to the first imaginary plane P1 but also relative to an imaginary plane P2 (hereinafter referred to as a “second imaginary plane P2”) which is orthogonal to the optical axis AX2 of the second projective optical system 2. The screen S is also tilted relative to the second imaginary plane P2.

As above, in the projecting device 100 to which the Scheimpflug rule is applied twice, the light emitted from the display unit 4 (displaying a rectangular image) passes through the first projective optical system 1 and forms the intermediate image having trapezoidal distortion. The light which formed the intermediate image having the trapezoidal distortion is diverged by the second projective optical system 2 and forms an enlarged and rectangular image (in which the trapezoidal distortion has been corrected) on the screen S, by which the user (viewer) can see the enlarged image with no trapezoidal distortion.

As shown in FIG. 2, the second projective optical system 2 of this embodiment includes lenses each of which is placed to let the first and second ray bundles U and D enter its lens surface (irrespective of whether the surface is a first surface or a second surface) at positions apart from each other (with the two incident ray bundles having no overlapping part). In this explanation, a surface of each lens (placed on the optical paths of the first through third ray bundles U-C) nearer to the screen S will be called a “first surface”, while a surface of each lens nearer to the display unit 4 will be called a “second surface”. Specifically, such lenses include a lens 21 (specified by surface Nos. r3 and r4) nearest to the screen S and two lenses 22 and 23 (specified by surface Nos. r18, r19, r20 and r21) nearby the deflecting optical system 3. Among the lenses 21-23, a lens placed on the screen S side of the screen-side pupil (pupil on the screen S side) of the second projective optical system 2 (i.e. the lens 21 in this example) has a function as a “corrective lens” for correcting the aspect ratio of the projected image and increasing the incident angle of the light entering the screen S.

The corrective lens 21 is configured as explained below. FIG. 4 is an enlarged view showing optical paths of the first through third ray bundles U-C in the vicinity of the corrective lens 21. In FIG. 4, a position where the principal ray Lc of the third ray bundle C crosses the first surface 21a (surface No. r3 in FIG. 2) of the corrective lens 21 is defined as “p1”, and a position where the principal ray Lc crosses the second surface 21b (surface No. r4 in FIG. 2) of the corrective lens 21 is defined as “p2”. On the first surface 21a, positions where the principal rays Lu and Ld of the first and second ray bundles U and D cross the first surface 21a are defined as “p3” and “p5”, respectively. On the second surface 21b, positions where the principal rays Lu and Ld cross the second surface 21b are defined as “p4” and “p6”, respectively.

The corrective lens 21 is designed to satisfy the following condition (1):
s1−s2>0 (1)

where “s1” denotes the gradient of a tangent line (in the lengthwise direction corresponding to the vertical direction of the screen S) to the first surface 21a at the position p1 and “s2” denotes the gradient of a tangent line (in the lengthwise direction) to the second surface 21b at the position p2.

By designing the corrective lens 21 to satisfy the above condition (1), a prism effect, bending the ray bundles (entering the corrective lens 21) steeply upward (to be close to the vertical direction of the screen S), can be achieved.

The corrective lens 21 is designed to further satisfy the following condition (2):
(c1−c3)>(c2−c4) (2)

where “c1” and “c2” denote curvatures of the first surface 21a measured at the position p1 in the lengthwise direction and in the crosswise direction respectively and “c3” and “c4” denote curvatures of the second surface 21b measured at the position p2 in the lengthwise direction and in the crosswise direction respectively.

By satisfying the above condition (2), the corrective lens 21 has an anamorphic shape at least in an area where the light emitted by the display unit 4 is incident (especially in an area where the third ray bundle C is incident), by which the aspect ratio of the image projected on the screen S is corrected properly. Specifically, magnification in the crosswise direction is enhanced and the projected image is stretched in the horizontal direction.

The corrective lens 21 is designed to further satisfy the following condition (3):
Cd<Cc<Cu (3)

where “Cu” denotes the difference between curvature of the first surface 21a measured at the position p3 in the lengthwise direction and curvature of the second surface 21b measured at the position p4 in the lengthwise direction, “Cc” denotes the difference between the curvature of the first surface 21a measured at the position p1 in the lengthwise direction and the curvature of the second surface 21b measured at the position p2 in the lengthwise direction (i.e. the aforementioned (c1−c3)), and “Cd” denotes the difference between curvature of the first surface 21a measured at the position p5 in the lengthwise direction and curvature of the second surface 21b measured at the position p6 in the lengthwise direction.

With the above condition (3), an effect of correcting the difference in magnification in the lengthwise direction (vertical direction) between the upper part and lower part of the projected image (the effect becomes insufficient when the incident angle of the light entering the screen S is set still larger for reducing the size and thickness of the projecting device 100 if the effect is achieved only by determining the positional relationship among the screen S and the elements of the projective optical system 10 according to the Scheimpflug rule) can be enhanced.

Further, the corrective lens 21 is designed so that the curvature differences Cd, Cc and Cu will satisfy the following condition (4) in relation to the tilt angle α (see FIG. 3) of the display unit 4 relative to the first imaginary plane P1.

$$1 \leq \frac{Cu - Cc}{Cc - Cd} < {( \frac{- 2 sin α + cos α}{- sin α + cos α} )}^{2} . \qquad ( 4 )$$

In the above condition (4), the middle side (expression) represents the ratio between an image size reducing effect of the corrective lens 21 in the lengthwise direction in the vicinity of the upper end of the projected image and the image size reducing effect in the vicinity of the lower end of the projected image. The right side represents the ratio between an aspect ratio in the vicinity of the upper end of the image projected on the screen S without the corrective lens 21 and the aspect ratio in the vicinity of the lower end of the image projected without the corrective lens 21. In short, the condition (4) is employed for properly setting the curvatures of the corrective lens 21 so as to let the image size reducing effect in the lengthwise direction in the vicinity of the upper end be larger than the image size reducing effect in the lengthwise direction in the vicinity of the lower end while avoiding excessive correction exceeding a change in the aspect ratio caused by the use of the Scheimpflug rule.

In order to satisfy the above conditions (1)-(4), at least one surface of the corrective lens 21 is configured as, for example, a “rotationally asymmetric polynomial surface” such as a free curved surface. The rotationally asymmetric polynomial surface can be expressed by use of a coordinate system having a Y-axis (parallel to the aforementioned reference plane and orthogonal to the optical axis of the surface), a Z-axis (orthogonal to both the reference plane and the optical axis) and an X-axis (orthogonal to the Y-axis and Z-axis) extending from the origin. Specifically, the rotationally asymmetric polynomial surface in the coordinate system is expressed by the following expression (5):

$$X ( y , z ) = \frac{{y}^{2} + {z}^{2}}{r ( 1 + \sqrt{1 - \frac{( K + 1 ) ( {y}^{2} + {z}^{2} )}{{r}^{2}}} )} + \sum {B}_{mn} {y}^{m} {z}^{n} \qquad ( 5 )$$

where “X (y, z)” denotes the SAG amount (distance from a tangential plane contacting the lens surface on the optical axis) of a point on the lens surface having coordinates (y, z), “r” denotes a curvature radius, “K” denotes a cone constant, and “Bₘₙ” denotes an aspherical coefficient for each term y^{m}zⁿ.

When rotationally asymmetric polynomial surfaces specified by the expression (5) are employed for the corrective lens 21, setting the coefficient B₄₀ of the first surface 21a larger than that of the second surface 21b serves as a sufficient condition for the condition (3).

As the rotationally asymmetric polynomial surface, not only free curved surfaces but also the so-called toric aspherical surfaces (having nonzero coefficients Bₘₙ only for terms with even m and n in the expression (5)) can be employed.

The conditions (1)-(4) can also be satisfied by employing a “rotationally symmetric aspherical surface” for at least one surface of the corrective lens 21. The corrective lens 21 having a rotationally symmetric aspherical surface is designed so that the difference between curvature of the first surface 21a due to aspherical components and curvature of the second surface 21b due to aspherical components will increase as the height y from the axis of rotational symmetry increases. Incidentally, the “curvature due to aspherical components” means the difference between curvature at an arbitrary height y taking the aspherical shape in account and curvature at the height y without taking the aspherical shape in account (considering the lens surface as a spherical surface). The shape of the rotationally symmetric aspherical surface is expressed by the following expression (6):

$$X ( y ) = \frac{{Cy}^{2}}{1 + \sqrt{1 - ( K + 1 ) {C}^{2} {y}^{2}}} + {A}_{4} {y}^{4} + {A}_{6} {y}^{6} + … \qquad ( 6 )$$

where “X (y)” denotes the SAG amount (distance from a tangential plane contacting the aspherical surface on the rotational symmetry axis) at a coordinate point on the aspherical surface where the height from the rotational symmetry axis is y, “C” denotes a curvature (1/r) of the aspherical surface on the rotational symmetry axis, “K” denotes a cone constant, and “A₄”, “A₆”, . . . denote aspherical coefficients.

When such a rotationally symmetric aspherical surface is employed for the corrective lens 21 the rotational symmetry axis of the corrective lens 21 is shifted from the optical axis AX2. Specifically, when paraxial power of the corrective lens 21 having a rotationally symmetric aspherical surface is positive, the rotational symmetry axis of the corrective lens 21 is shifted from the optical axis AX2 to separate from the second reference line L2 shown in FIG. 3. On the other hand, when the paraxial power of the corrective lens 21 is negative, the rotational symmetry axis of the corrective lens 21 is shifted from the optical axis AX2 toward the second reference line L2. Incidentally, it is also possible to slightly tilt the corrective lens 21 as needed in order to enhance the effects achieved by the conditions (1)-(4).

In the following, three concrete examples of the projecting device 100 in accordance with this embodiment will be described in detail. In each example, the display unit 4 is assumed to be 10.46 mm in height and 18.85 mm in width and the projecting magnification is assumed to be 71.43.

### FIRST EXAMPLE

In the projecting device 100 of the first example, the screen S and the projective optical system 10 are arranged as shown in FIG. 2. The following Table 1 shows specific numerical values of the projecting device 100 of the first example. The “tilt” (deg) of each element in Table 1 means a tilt angle from the first/second imaginary plane P1/P2 (see FIG. 3) which is orthogonal to the optical axis AX1/AX2. A positive tilt means a tilt in the counterclockwise direction in FIG. 2. The “shift amount” of each element in Table 1 means a shift amount of the center of the element from the optical axis AX1/AX2 measured while maintaining the tilt in regard to the optical axis AX1/AX2. A positive shift amount Y means a shift (of the center of the element) from the optical axis AX1/AX2 in a direction separating from the first/second reference line L1/L2 (ditto for the following examples).

TABLE 1

| | | Curvature | Surface | | | Shift | | Aspherical | Aspherical | |
|---|---|---|---|---|---|---|---|---|---|---|
| | Surface | radius | interval | Refractive | Abbe | amount | Tilt | Coefficient | Coefficient | |
| | No. | (mm) | (mm) | index | number | (mm) | [deg.] | (4^{th} order) | (6^{th} order) | Comments |
| Screen S | 0 | ∞ | 0.0 | | | | | | | |
| 2^{nd} | 1 | ∞ | 820.0 | | | | −34.3 | | | |
| Projective | 2 | ∞ | 0.0 | | | −12.0 | | | | |
| optical | 3 | 132.4 | 5.0 | 1.493 | 55.2 | | −3.8 | 1.1024E−06 | −6.6455E−11 | *1 |
| system | 4 | 45.0 | 0.0 | | | | | −3.3781E−07 | −2.6587E−09 | *1 |
| | 5 | ∞ | −5.0 | | | | 3.8 | | | |
| | 6 | ∞ | 20.1 | | | 12.0 | | | | |
| | 7 | 27.7 | 3.6 | 1.831 | 28.7 | | | | | |
| | 8 | 14.7 | 15.3 | | | | | | | |
| | 9 | −15.8 | 3.0 | 1.767 | 37.8 | | | | | |
| | 10 | 34.3 | 8.9 | 1.693 | 49.1 | | | | | |
| | 11 | −23.7 | 0.5 | | | | | | | |
| | 12 | 46.2 | 5.7 | 1.846 | 23.8 | | | | | |
| | 13 | −202.3 | 27.4 | | | | | | | |
| | 14 | −6468.1 | 8.3 | 1.768 | 46.2 | | | | | |
| | 15 | −19.5 | 1.8 | 1.836 | 31.0 | | | | | |
| | 16 | 37.2 | 8.3 | 1.558 | 67.0 | | | | | |
| | 17 | −44.6 | 30.1 | | | | | | | |
| | 18 | 151.3 | 5.0 | 1.826 | 43.2 | | | | | |
| | 19 | −384.5 | 6.7 | | | | | | | |
| | 20 | 42.2 | 7.1 | 1.603 | 65.5 | | | | | |
| | 21 | 103.8 | 4.0 | | | | | | | |
| Deflecting | 22 | ∞ | 0.0 | | | −5.2 | | | | |
| optical | 23 | ∞ | 0.0 | | | | −14.7 | | | |
| system 3 | 24 | ∞ | 14.7 | | | | −19.9 | | | *2 |
| | 25 | ∞ | 14.0 | 1.709 | 30.3 | | 40.0 | | | *2 |
| | 26 | ∞ | 14.7 | 1.751 | 26.4 | | −40.0 | | | *2 |
| | 27 | ∞ | 10.0 | 1.814 | 43.8 | | 10.2 | | | *2 |
| | 28 | ∞ | 18.5 | | | | | | | |
| 1^{st} | 29 | ∞ | 0.0 | | | −0.9 | | | | |
| Projective | 30 | ∞ | 0.0 | | | | −14.9 | | | |
| optical | 31 | ∞ | 12.2 | | | | | | | |
| system | 32 | ∞ | 8.8 | | | | | | | |
| | 33 | 21.9 | 7.6 | 1.603 | 65.4 | | | −2.1811E−05 | −2.0839E−08 | *1 |
| | 34 | −75.6 | 0.6 | | | | | −2.9204E−06 | 1.3955E−08 | *1 |
| | 35 | 13.9 | 5.7 | 1.720 | 50.0 | | | | | |
| | 36 | 29.4 | 2.0 | 1.787 | 25.3 | | | | | |
| | 37 | 8.1 | 8.1 | | | | | | | |
| | 38 | ∞ | 0.5 | | | | | | | |
| | 39 | 27.0 | 2.0 | 1.771 | 30.5 | | | | | |
| | 40 | 10.6 | 4.0 | 1.830 | 42.4 | | | | | |
| | 41 | −18.5 | 0.5 | | | | | | | |
| | 42 | 33.8 | 2.2 | 1.821 | 41.1 | | | −3.6117E−04 | 2.2988E−06 | *1 |
| | 43 | 13.1 | 0.0 | | | | | −4.0140E−04 | 2.9526E−06 | *1 |
| | 44 | ∞ | 1.3 | | | | −26.5 | | | |
| display | 45 | ∞ | 0.0 | | | 3.7 | | | | |
| unit 4 | | | | | | | | | | |

In Table 1, the surface No. 0 represents the screen S, the surface Nos. 1-21 represent the second projective optical system 2, the surface Nos. 22-28 represent the deflecting optical system 3, the surface Nos. 29-44 represent the first projective optical system 1, and the surface No. 45 represents the display unit 4. In the first example, the screen-side pupil of the second projective optical system 2 is at a position that is 113.8 mm on the screen S side of the surface No. 21. Therefore, the aforementioned “corrective lens 21” in the first example corresponds to a lens placed on the screen S side of the surface No. 8, that is, a lens (specified by the surface Nos. 3 and 4) nearest to the screen S. In “comments” fields in Table 1, “*1” represents a rotationally symmetric aspherical surface, and “*2” represents “coordinates unchanged”.

The surface Nos. 1, 2, 5, 6, 22-24, 29-32 and 44 represent imaginary planes (decentering definition planes) each of which is imaginarily placed for defining decentering status (tilt, shift, etc.) of a surface immediately after the imaginary plane. The surface No. 3 represents an actual lens surface in the second projective optical system 2, which is also a decentering definition plane. The surface Nos. 25-27 represent surfaces of the three prisms forming the deflecting optical system 3, which are also decentering definition planes. The surface No. 45 (display unit 4) is also a decentering definition plane. Each coordinate system after each decentering is represented by relative coordinates which are defined with reference to the state on the decentering definition plane. Incidentally, for the surface Nos. 24-27, the coordinate system is defined with reference to the state on the corrective lens 21 (changes in the coordinates caused by the tilting are not taken into consideration).

The surface Nos. 3, 4, 33, 34, 42 and 43 represent rotationally symmetric aspherical surfaces specified by the aspherical coefficients (of the fourth and sixth orders) shown in Table 1. Incidentally, “E−n” (n: integer) in the aspherical coefficients in Table 1 means 10⁻ⁿ (ditto for the following tables). In the first through third examples, the cone constant K and aspherical coefficients of orders unshown in the table are all 0 for every aspherical surface.

As above, in the corrective lens 21 in the first example, both the first and second surfaces 21a and 21b are rotationally symmetric aspherical surfaces. Since the paraxial power of the corrective lens 21 is negative, the shift amount of the corrective lens 21 is set at −12 mm, that is, the corrective lens 21 is shifted toward the second reference line L2 by 12 mm.

On the second surface 21b of the corrective lens 21, a Y coordinate representing incidence height of the lowest ray (nearest to the optical axis AX2) in the first ray bundle U is 9.585 while a Y coordinate representing incidence height of the highest ray (farthest from the optical axis AX2) in the second ray bundle D is 8.523, that is, the first and second ray bundles U and D are incident upon the corrective lens 21 in the first example totally separately from each other.

In the first example, with the above configuration and placement of the corrective lens 21 the aforementioned gradients s1 and s2 are −4.119 and −4.331, respectively (s1−s2=0.212>0). Therefore, the first example satisfies the condition (1). The curvatures c1, c2, c3 and c4 are 0.018, 0.007, 0.005 and 0.025, respectively (c1−c3 (=Cc)=0.013, c2−c4=−0.018), and thus the first example also satisfies the condition (2).

The curvature differences Cd, Cc and Cu are −0.020, 0.013 and 0.029, respectively, and thus the first example also satisfies the condition (3). The tilt angle α of the display unit 4 is −26.5 degrees as shown in Table 1. Substituting the values of Cd, Cc, Cu and α into the condition (4) proves that the first example also satisfies the condition (4).

### SECOND EXAMPLE

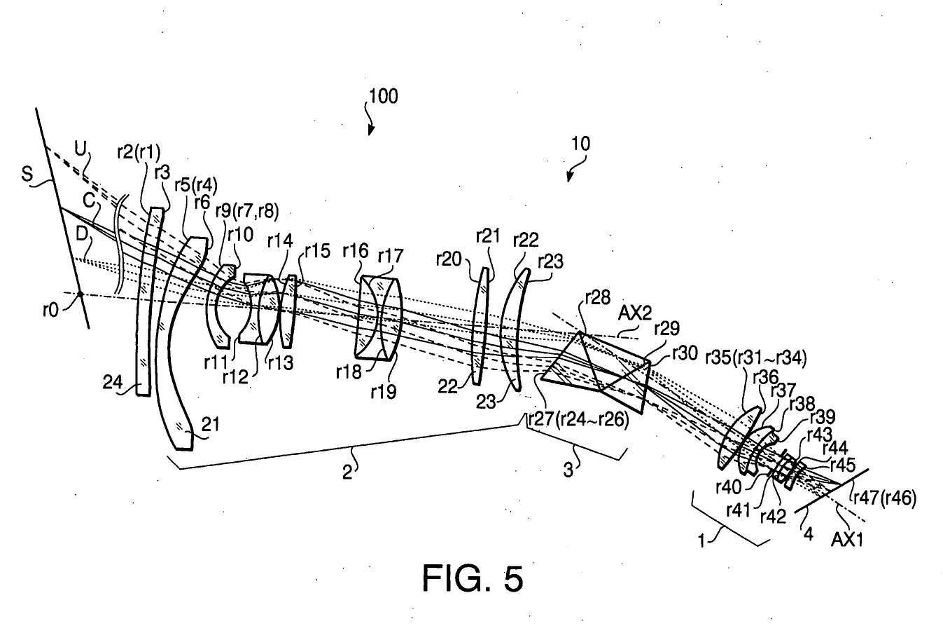

FIG. 5 is a schematic diagram mainly showing the composition of a projective optical system 10 of a projecting device 100 as the second example, in which optical paths inside the projecting device 100 (between the projective optical system 10 and the screen S) are unfolded for convenience. The following Table 2 shows specific numerical values of the projecting device 100 of the second example.

TABLE 2

| | | Curvature | Surface | | | Shift | | Aspherical | Aspherical | |
|---|---|---|---|---|---|---|---|---|---|---|
| | Surface | radius | interval | Refractive | Abbe | amount | Tilt | Coefficient | Coefficient | |
| | No. | (mm) | (mm) | index | number | (mm) | [deg.] | (4^{th} order) | (6^{th} order) | Comments |
| Screen S | 0 | ∞ | 0.0 | | | | | | | |
| 2^{nd} | 1 | ∞ | 820.0 | | | | −34.3 | | | |
| Projective | 2 | 330.0 | 5.0 | 1.634 | 1.6 | | | | | |
| optical | 3 | 258.8 | 3.8 | | | | | | | |
| system | 4 | ∞ | 0.0 | | | −12.0 | | | | |
| | 5 | 132.4 | 5.0 | 1.493 | 55.2 | | −3.8 | 1.1024E−06 | −6.6455E−11 | *1 |
| | 6 | 45.0 | 0.0 | | | | | −3.3781E−07 | −2.6587E−09 | *1 |
| | 7 | ∞ | −5.0 | | | | 3.8 | | | |
| | 8 | ∞ | 28.3 | | | 12.0 | | | | |
| | 9 | 27.7 | 3.6 | 1.831 | 28.7 | | | | | |
| | 10 | 14.7 | 15.3 | | | | | | | |
| | 11 | −15.8 | 3.0 | 1.767 | 37.8 | | | | | |
| | 12 | 34.3 | 8.9 | 1.693 | 49.1 | | | | | |
| | 13 | −23.7 | 0.5 | | | | | | | |
| | 14 | 46.2 | 5.7 | 1.846 | 23.8 | | | | | |
| | 15 | −202.3 | 27.4 | | | | | | | |
| | 16 | −6468.1 | 8.3 | 1.768 | 46.2 | | | | | |
| | 17 | −19.5 | 1.8 | 1.836 | 31.0 | | | | | |
| | 18 | 37.2 | 8.3 | 1.558 | 67.0 | | | | | |
| | 19 | −44.6 | 30.1 | | | | | | | |
| | 20 | 151.3 | 5.0 | 1.826 | 43.2 | | | | | |
| | 21 | −384.5 | 6.7 | | | | | | | |
| | 22 | 42.2 | 7.1 | 1.603 | 65.5 | | | | | |
| | 23 | 103.8 | 4.0 | | | | | | | |
| Deflecting | 24 | ∞ | 0.0 | | | −5.2 | | | | |
| optical | 25 | ∞ | 0.0 | | | | −14.7 | | | |
| system 3 | 26 | ∞ | 14.7 | | | | −19.9 | | | *2 |
| | 27 | ∞ | 14.0 | 1.709 | 30.3 | | 40.0 | | | *2 |
| | 28 | ∞ | 14.7 | 1.751 | 26.4 | | −40.0 | | | *2 |
| | 29 | ∞ | 10.0 | 1.814 | 43.8 | | 10.2 | | | *2 |
| | 30 | ∞ | 18.5 | | | | | | | |
| 1^{st} | 31 | ∞ | 0.0 | | | −0.9 | | | | |
| Projective | 32 | ∞ | 0.0 | | | | −14.9 | | | |
| optical | 33 | ∞ | 12.2 | | | | | | | |
| system | 34 | ∞ | 8.8 | | | | | | | |
| | 35 | 21.9 | 7.6 | 1.603 | 65.4 | | | −2.1811E−05 | −2.0839E−08 | *1 |
| | 36 | −75.6 | 0.6 | | | | | −2.9204E−06 | 1.3955E−08 | *1 |
| | 37 | 13.9 | 5.7 | 1.720 | 50.0 | | | | | |
| | 38 | 29.4 | 2.0 | 1.787 | 25.3 | | | | | |
| | 39 | 8.1 | 8.1 | | | | | | | |
| | 40 | ∞ | 0.5 | | | | | | | |
| | 41 | 27.0 | 2.0 | 1.771 | 30.5 | | | | | |
| | 42 | 10.6 | 4.0 | 1.830 | 42.4 | | | | | |
| | 43 | −18.5 | 0.5 | | | | | | | |
| | 44 | 33.8 | 2.2 | 1.821 | 41.1 | | | −3.6117E−04 | 2.2988E−06 | *1 |
| | 45 | 13.1 | 0.0 | | | | | −4.0140E−04 | 2.9526E−06 | *1 |
| | 46 | ∞ | 1.3 | | | | −26.5 | | | |
| display | 47 | ∞ | 0.0 | | | 3.7 | | | | |
| unit 4 | | | | | | | | | | |

In Table 2, the surface No. 0 represents the screen S, the surface Nos. 1-23 represent the second projective optical system 2, the surface Nos. 24-30 represent the deflecting optical system 3, the surface Nos. 31-46 represent the first projective optical system 1, and the surface No. 47 represents the display unit 4. In the second example, the screen-side pupil of the second projective optical system 2 is at a position that is 124.0 mm on the screen S side of the surface No. 23. Therefore, the “corrective lens 21” in the second example corresponds to a lens placed on the screen S side of the surface No. 10. Since an optical element 24 like a parallel flat plate (having extremely low power) is placed next to the screen S in the second example, the second lens (specified by the surface Nos. 5 and 6) from the screen S is the corrective lens 21 in the second example. As in this example, the corrective lens 21 does not necessarily have to be the nearest to the screen S; any lens on the screen S side of the screen-side pupil of the second projective optical system 2 can be configured as the corrective lens 21. In “comments” fields in Table 2, “*1” represents a rotationally symmetric aspherical surface, and “*2” represents “coordinates unchanged”.

The surface Nos. 1, 4, 7, 8, 24-26, 31-34 and 46 represent decentering definition planes. The surface Nos. 5, 27-29 and 47 represent actual surfaces existing in the projective optical system 10, which are also decentering definition planes. Similarly to the first example, each coordinate system after each decentering is represented by relative coordinates which are defined with reference to the state on the decentering definition plane. Incidentally, for the surface Nos. 26-29, the coordinate system is defined with reference to the state on the corrective lens 21 (changes in the coordinates caused by the tilting are not taken into consideration).

The surface Nos. 5, 6, 35, 36, 44 and 45 represent rotationally symmetric aspherical surfaces specified by the aspherical coefficients (of the fourth and sixth orders) shown in Table 2. As mentioned before, the cone constant K and aspherical coefficients of orders unshown in Table 2 are all 0 for every aspherical surface. As shown in Table 2, both the first and second surfaces 21a and 21b of the corrective lens 21 in the second example are rotationally symmetric aspherical surfaces. Since the paraxial power of the corrective lens 21 is negative, the shift amount of the corrective lens 21 is set at −12 mm, that is, the corrective lens 21 is shifted toward the second reference line L2 by 12 mm.

On the second surface 21b of the corrective lens 21, a Y coordinate representing incidence height of the lowest ray (nearest to the optical axis AX2) in the first ray bundle U is 26.162 while a Y coordinate representing incidence height of the highest ray (farthest from the optical axis AX2) in the second ray bundle D is 24.300, that is, the first and second ray bundles U and D are incident upon the corrective lens 21 in the second example totally separately from each other.

In the second example, with the above configuration and placement of the corrective lens 21 the gradients s1 and s2 are −4.243 and −4.461, respectively (s1−s2=0.218>0). Therefore, the second example satisfies the condition (1). The curvatures c1, c2, c3 and c4 are 0.018, 0.008, 0.006 and 0.027, respectively (c1−c3 (=Cc)=0.012, c2−c4=−0.019), and thus the second example also satisfies the condition (2).

The curvature differences Cd, Cc and Cu are −0.020, 0.012 and 0.030, respectively, and thus the second example also satisfies the condition (3). The tilt angle α of the display unit 4 is −26.5 degrees as shown in Table 2. Substituting the values of Cd, Cc, Cu and α into the condition (4) proves that the second example also satisfies the condition (4).

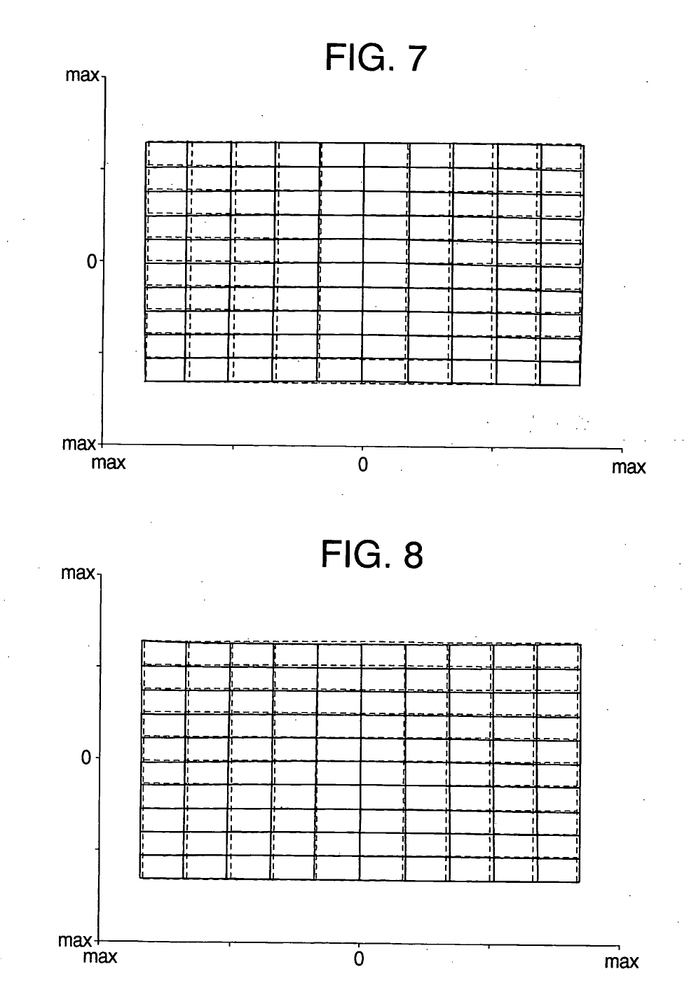

FIG. 7 is a graph showing distortion of images actually projected by the projecting devices of the first and second examples, in which solid lines represent the images actually projected on the screen S while broken lines represent an ideal image having no distortion. The actually projected images (solid lines in FIG. 7), exhibiting excellent reduction of distortion, are extremely close to the ideal image. As above, in the first and second examples, the aspect ratio can be maintained properly while securing a large incident angle by employing the corrective lens 21.

### THIRD EXAMPLE

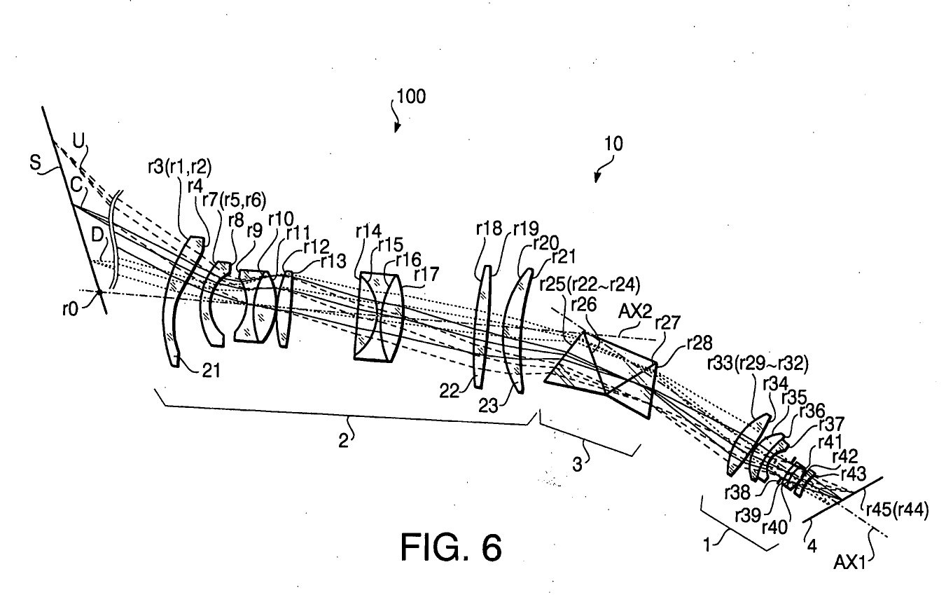

FIG. 6 is a schematic diagram mainly showing the composition of a projective optical system 10 of a projecting device 100 as the third example, in which optical paths inside the projective device 100 (between the projective optical system 10 and the screen S) are unfolded for convenience. The following Table 3 shows specific numerical values of the projecting device 100 of the third example.

TABLE 3

| | | Curvature | Surface | | | Shift | | Aspherical | Aspherical | |
|---|---|---|---|---|---|---|---|---|---|---|
| | Surface | radius | interval | Refractive | Abbe | amount | Tilt | Coefficient | Coefficient | |
| | No. | (mm) | (mm) | index | number | (mm) | [deg.] | (4^{th} order) | (6^{th} order) | Comments |
| Screen S | 0 | ∞ | 0.0 | | | | | | | |
| 2^{nd} | 1 | ∞ | 820.0 | | | | −34.3 | | | |
| projective | 2 | ∞ | 0.0 | | | | | | | |
| optical | 3 | 65.2 | 5.0 | 1.493 | 55.2 | | | | | *3 |
| system | 4 | 30.2 | 0.0 | | | | | | | *3 |
| | 5 | ∞ | −5.0 | | | | | | | |
| | 6 | ∞ | 14.5 | | | | | | | |
| | 7 | 27.7 | 3.6 | 1.831 | 28.7 | | | | | |
| | 8 | 14.7 | 15.3 | | | | | | | |
| | 9 | −15.8 | 3.0 | 1.767 | 37.8 | | | | | |
| | 10 | 34.3 | 8.9 | 1.693 | 49.1 | | | | | |
| | 11 | −23.7 | 0.5 | | | | | | | |
| | 12 | 46.2 | 5.7 | 1.846 | 23.8 | | | | | |
| | 13 | −202.3 | 27.4 | | | | | | | |
| | 14 | −6468.1 | 8.3 | 1.768 | 46.2 | | | | | |
| | 15 | −19.5 | 1.8 | 1.836 | 31.0 | | | | | |
| | 16 | 37.2 | 8.3 | 1.558 | 67.0 | | | | | |
| | 17 | −44.6 | 30.1 | | | | | | | |
| | 18 | 151.3 | 5.0 | 1.826 | 43.2 | | | | | |
| | 19 | −384.5 | 6.7 | | | | | | | |
| | 20 | 42.2 | 7.1 | 1.603 | 65.5 | | | | | |
| | 21 | 103.8 | 4.0 | | | | | | | |
| Deflecting | 22 | ∞ | 0.0 | | | −5.2 | | | | |
| optical | 23 | ∞ | 0.0 | | | | −14.7 | | | |
| system 3 | 24 | ∞ | 14.7 | | | | −19.9 | | | *2 |
| | 25 | ∞ | 14.0 | 1.709 | 30.3 | | 40.0 | | | *2 |
| | 26 | ∞ | 14.7 | 1.751 | 26.4 | | −40.0 | | | *2 |
| | 27 | ∞ | 10.0 | 1.814 | 43.8 | | 10.2 | | | *2 |
| | 28 | ∞ | 18.5 | | | | | | | |
| 1^{st} | 29 | ∞ | 0.0 | | | −0.9 | | | | |
| projective | 30 | ∞ | 0.0 | | | | −14.9 | | | |
| optical | 31 | ∞ | 12.2 | | | | | | | |
| system | 32 | ∞ | 8.8 | | | | | | | |
| | 33 | 21.9 | 7.6 | 1.603 | 65.4 | | | −2.1811E−05 | −2.0839E−08 | *1 |
| | 34 | −75.6 | 0.6 | | | | | −2.9204E−06 | 1.3955E−08 | *1 |
| | 35 | 13.9 | 5.7 | 1.720 | 50.0 | | | | | |
| | 36 | 29.4 | 2.0 | 1.787 | 25.3 | | | | | |
| | 37 | 8.1 | 8.1 | | | | | | | |
| | 38 | ∞ | 0.5 | | | | | | | |
| | 39 | 27.0 | 2.0 | 1.771 | 30.5 | | | | | |
| | 40 | 10.6 | 4.0 | 1.830 | 42.4 | | | | | |
| | 41 | −18.5 | 0.5 | | | | | | | |
| | 42 | 33.8 | 2.2 | 1.821 | 41.1 | | | −3.6117E−04 | 2.2988E−06 | *1 |
| | 43 | 13.1 | 0.0 | | | | | −4.0140E−04 | 2.9526E−06 | *1 |
| | 44 | ∞ | 1.3 | | | | −26.5 | | | |
| display | 45 | ∞ | 0.0 | | | 3.7 | | | | |
| unit 4 | | | | | | | | | | |

In Table 3, the surface No. 0 represents the screen S, the surface Nos. 1-21 represent the second projective optical system 2, the surface Nos. 22-28 represent the deflecting optical system 3, the surface Nos. 29-44 represent the first projective optical system 1, and the surface No. 45 represents the display unit 4. In the third example, the screen-side pupil of the second projective optical system 2 is at a position that is 115.4 mm on the screen S side of the surface No. 21. Therefore, the “corrective lens 21” in the third example corresponds to a lens placed on the screen S side of the surface No. 8, that is, a lens (specified by the surface Nos. 3 and 4) nearest to the screen S. In “comments” fields in Table 3, “*1” represents a rotationally symmetric aspherical surface, “*2” represents “coordinates unchanged”, and “*3” represents a fee curved surface.

The surface Nos. 1, 22-24, 29-32 and 44 represent decentering definition planes. The surface Nos. 25-27 and 45 represent actual surfaces existing in the projective optical system 10, which are also decentering definition planes. Similarly to the first and second examples, each coordinate system after each decentering is represented by relative coordinates which are defined with reference to the state on the decentering definition plane. Incidentally, for the surface Nos. 24-27, the coordinate system is defined with reference to the state on the corrective lens 21 (changes in the coordinates caused by the tilting are not taken into consideration).

The surface Nos. 33, 34, 42 and 43 represent rotationally symmetric aspherical surfaces specified by the aspherical coefficients (of the fourth and sixth orders) shown in Table 3. As mentioned before, the cone constant K and aspherical coefficients of orders unshown in Table 2 are all 0 for every aspherical surface. The corrective lens 21 in the third example (specified by the surface Nos. 3 and 4) is a free curved surface (as a rotationally asymmetric polynomial surface) specified by the aforementioned expression (5). The following Table 4 shows coefficients specifying the free curved surface. In Table 4, aspherical coefficients Bₘₙ with odd m are also used in order to achieve an effect similar to decentering of the corrective lens 21. In the corrective lens 21 in the third example, the aspherical coefficient B₄₀ of the first surface 21a is set larger than that of the second surface 21b as shown in Table 4.

TABLE 4

| ASPHERICAL COEFFICIENTS | | |
|---|---|---|
| OF POLYNOMIAL SURFACE | #3 | #4 |
| K | 0 | 0 |
| B₁₀ | 7.1179E−02 | 2.6913E−01 |
| B₂₀ | 2.4578E−03 | 1.2430E−03 |
| B₃₀ | −9.3900E−06 | −2.7524E−04 |
| B₄₀ | −5.3100E−07 | −1.7600E−05 |
| B₂₁ | −5.9900E−05 | −3.2224E−04 |
| B₂₂ | −2.3900E−06 | −3.1200E−05 |
| B₀₄ | −6.8700E−06 | −2.2700E−05 |

On the second surface 21b of the corrective lens 21, a Y coordinate representing incidence height of the lowest ray (nearest to the optical axis AX2) in the first ray bundle U is 9.585 while a Y coordinate representing incidence height of the highest ray (farthest from the optical axis AX2) in the second ray bundle D is 8.522, that is, the first and second ray bundles U and D are incident upon the corrective lens 21 in the third example totally separately from each other.

In the third example, with the above configuration and placement of the corrective lens 21, the gradients s1 and s2 are −3.263 and −5.800, respectively (s1−s2=2.537>0). Therefore, the third example satisfies the condition (1). The curvatures c1, c2, c3 and c4 are 0.002, 0.020, 0.007 and 0.028, respectively (c1−c3 (=Cc)=−0.005, c2−c4=−0.008), and thus the third example also satisfies the condition (2).

The curvature differences Cd, Cc and Cu are −0.012, −0.005 and −0.001, respectively, and thus the third example also satisfies the condition (3). The tilt angle α of the display unit 4 is −26.5 degrees as shown in Table 2. Substituting the values of Cd, Cc, Cu and α into the condition (4) proves that the third example also satisfies the condition (4).

FIG. 8 is a graph showing distortion of an image actually projected by the projecting device 100 of the third example, in which solid lines represent the image actually projected on the screen S while broken lines represent an ideal image having no distortion. The actually projected image (solid lines in FIG. 8), exhibiting excellent reduction of distortion, are extremely close to the ideal image. As above, the third example also maintains the aspect ratio properly while securing a large incident angle by employing the corrective lens 21, similarly to the first and second examples.

As described above, in the projecting device 100 in accordance with the embodiment of the present invention, the corrective lens 21 (prescribed lens) is designed and placed to satisfy various conditions, by which both the effect of increasing the incident angle of the light entering the screen S and the effect of correcting the aspect ratio of the image projected on the screen S to that of the image displayed by the display unit 4 can be achieved by the corrective lens 21. Therefore, the aspect ratio of the projected image can be maintained properly while securing a high degree of freedom in the selection of magnification of each projective optical system. Further, a reduced thickness of the projecting device (in the direction orthogonal to the screen S) can be realized by the above effect of increasing the incident angle.

While a description has been given above of a preferred embodiment in accordance with the present invention, the present invention is not to be restricted by the particular illustrative embodiment and a variety of modifications, design changes, etc. are possible without departing from the scope and spirit of the present invention described in the appended claims.

Incidentally, while a corrective lens 21 having aspherical surfaces or free curved surfaces (rotationally asymmetric polynomial surface) on both sides is used in each example of the above embodiment, the projecting device in accordance with the present invention can achieve effects similar to those of the above embodiment even if the corrective lens 21 has an aspherical surface or free curved surface (rotationally asymmetric polynomial surface) only on one side.

A coma suppression effect, suppressing coma aberration caused by the decentering of the corrective lens 21 or the asymmetric shape of the corrective lens 21 corresponding to the decentering, can be achieved by shifting one or more lenses of the second projective optical system 2 nearest to the intermediate image from the optical axis oppositely to the shift of the corrective lens 21.

This application claims priority of Japanese Patent Application No. P2005-202797, filed on Jul. 12, 2005. The entire subject matter of the application is incorporated herein by reference.

What is claimed is:

1. A projecting device, comprising:
a display unit which displays an image in a rectangular shape;
a first projective optical system which forms an intermediate image having trapezoidal distortion from light emitted by the display unit;
a second projective optical system which receives the light after forming the intermediate image and projects the light obliquely onto a screen so that an enlarged image in which the trapezoidal distortion has been corrected will be projected on the screen; and
an intermediate optical system which combines pupils of the first and second projective optical systems and leads the light emerging from the first projective optical system to the second projective optical system, wherein:
at least the second projective optical system includes at least one lens having a surface on which a first ray bundle emitted from one end of the image displayed by the display unit in regard to a short side direction of the image and a second ray bundle emitted from the other end of the image in regard to the short side direction are totally separate from each other, and
a prescribed lens included in the at least one lens has a first surface on the screen side and a second surface on the display unit side and satisfies the following condition (1) in regard to a third ray bundle emitted from the center of the image displayed by the display unit:
s1−s2>0 (1)
where s1 denotes a gradient of a tangent line to the first surface in a lengthwise direction corresponding to a vertical direction of the screen measured at a position where a principal ray of the third ray bundle crosses the first surface and s2 denotes a gradient of a tangent line to the second surface in the lengthwise direction measured at a position where the principal ray of the third ray bundle crosses the second surface, and
the prescribed lens satisfies the following condition (2):
(c1−c3)>(c2−c4) (2)
where c1 and c2 denote curvatures of the first surface in the lengthwise direction and in a crosswise direction corresponding to a horizontal direction of the screen measured at the position where the principal ray of the third ray bundle crosses the first surface and c3 and c4 denote curvatures of the second surface in the lengthwise direction and in the crosswise direction measured at the position where the principal ray of the third ray bundle crosses the second surface.

2. The projecting device according to claim 1, wherein the prescribed lens satisfies the following condition (3):
Cd<Cc<Cu (3)
where Cu denotes difference between curvature of the first surface in the lengthwise direction measured at a position where a principal ray of the first ray bundle crosses the first surface and curvature of the second surface in the lengthwise direction measured at a position where the principal ray of the first ray bundle crosses the second surface, Cd denotes difference between curvature of the first surface in the lengthwise direction measured at a position where a principal ray of the second ray bundle crosses the first surface and curvature of the second surface in the lengthwise direction measured at a position where the principal ray of the second ray bundle crosses the second surface, and Cc denotes difference between the curvature of the first surface in the lengthwise direction measured at the position where the principal ray of the third ray bundle crosses the first surface and the curvature of the second surface in the lengthwise direction measured at the position where the principal ray of the third ray bundle crosses the second surface.

3. The projecting device according to claim 2, wherein the prescribed lens satisfies the following condition (4) in relation to a tilt angle α (degrees) of the display unit relative to a plane orthogonal to an optical axis of the first projective optical system:
$$1 \leq \frac{Cu - Cc}{Cc - Cd} < {( \frac{- 2 sin α + cos α}{- sin α + cos α} )}^{2} . \qquad ( 4 )$$

4. The projecting device according to claim 1, wherein:
each of the first and second surfaces of the prescribed lens has a shape defined by the following expression (5):
$$X ( y , z ) = \frac{{y}^{2} + {z}^{2}}{r ( 1 + \sqrt{1 - \frac{( K + 1 ) ( {y}^{2} + {z}^{2} )}{{r}^{2}}} )} + \sum {B}_{mn} {y}^{m} {z}^{n} \qquad ( 5 )$$
where X(y, z) denotes a SAG amount from a tangential plane contacting the surface on its optical axis to a point on the surface having coordinates (y, z) when the tangential plane is expressed in a coordinate system specified by a Y-axis extending in the lengthwise direction from the optical axis and a Z-axis orthogonal to both the optical axis and the Y-axis to have an origin as an intersection point of the Y-axis, the Z-axis and the optical axis, r denotes a curvature radius, K denotes a cone constant, and Bₘₙ denotes an aspherical coefficient for each term y^{m}zⁿ, and
at least one of the first and second surfaces is a polynomial surface that is rotationally asymmetric around the optical axis with a nonzero aspherical coefficient Bₘₙ in which m≠n, and
the aspherical coefficient B₄₀ of the first surface is set larger than that of the second surface.

5. The projecting device according to claim 1, wherein:
each of the first and second surfaces of the prescribed lens is a rotationally symmetric aspherical surface having a shape defined by the following expression (6):
$$X ( y ) = \frac{{Cy}^{2}}{1 + \sqrt{1 - ( K + 1 ) {C}^{2} {y}^{2}}} + {A}_{4} {y}^{4} + {A}_{6} {y}^{6} + … \qquad ( 6 )$$
where X (y) denotes a SAG amount from a tangential plane contacting the aspherical surface on its rotational symmetry axis to a coordinate point on the aspherical surface where height from the rotational symmetry axis is y, C denotes curvature of the aspherical surface on the rotational symmetry axis, K denotes a cone constant, and A₄, A₆, . . . denote aspherical coefficients, and
the aspherical coefficients A₄ and A₆ of the fourth and sixth orders are both nonzero for at least one of the first and second surfaces, and
at least the prescribed lens is shifted from an optical axis of the second projective optical system.

6. The projecting device according to claim 5, wherein the prescribed lens is configured so that difference between curvature of the first surface due to aspherical components and curvature of the second surface due to aspherical components will be positive and increase as the height from the rotational symmetry axis increases.

7. The projecting device according to claim 1, wherein the prescribed lens is placed on the screen side of a screen-side pupil of the second projective optical system.

8. The projecting device according to claim 5, wherein:
the prescribed lens is placed on the screen side of a screen-side pupil of the second projective optical system, and
the prescribed lens is configured to have positive paraxial power, and
the prescribed lens is shifted from the optical axis of the second projective optical system to separate from an intersection line where three planes extending from the screen, a principal plane of the second projective optical system and an image plane of the intermediate image intersect with one another.

9. The projecting device according to claim 5, wherein:
the prescribed lens is placed on the screen side of a screen-side pupil of the second projective optical system, and
the prescribed lens is configured to have negative paraxial power, and
the prescribed lens is shifted from the optical axis of the second projective optical system toward an intersection line where three planes extending from the screen, a principal plane of the second projective optical system and an image plane of the intermediate image intersect with one another.

10. The projecting device according to claim 6, wherein:
the prescribed lens is placed on the screen side of a screen-side pupil of the second projective optical system, and
the prescribed lens is configured to have positive paraxial power, and
the prescribed lens is shifted from the optical axis of the second projective optical system to separate from an intersection line where three planes extending from the screen, a principal plane of the second projective optical system and an image plane of the intermediate image intersect with one another.

11. The projecting device according to claim 6, wherein:
the prescribed lens is placed on the screen side of a screen-side pupil of the second projective optical system, and
the prescribed lens is configured to have negative paraxial power, and
the prescribed lens is shifted from the optical axis of the second projective optical system toward an intersection line where three planes extending from the screen, a principal plane of the second projective optical system and an image plane of the intermediate image intersect with one another.

12. The projecting device according to claim 1, wherein:
the short side direction corresponds to the vertical direction of the image projected and displayed on the screen, and
the one end and the other end in regard to the short side direction are an upper end and a lower end of the image displayed by the display unit respectively.
